(19) United States
(12) Patent Application Publication
(10) Pub. No.: US 2019/0302808 A1
(43) Pub. Date: Oct. 3, 2019

(54) METHOD AND A SYSTEM FOR CONTROLLING THE TRAJECTORY OF AN AIRCRAFT

(71) Applicant: Airbus Operations (S.A.S.), Toulouse (FR)

(72) Inventors: Jean-luc Robin, SAINT-JEAN (FR); José Torralba, Merville (FR); Julie Lebas, Toulouse (FR)

(21) Appl. No.: 16/363,156

(22) Filed: Mar. 25, 2019

(30) Foreign Application Priority Data
Mar. 27, 2018 (FR) 1852633

(51) Int. Cl. G05D 1/10; G08G 5/04; G08G 5/00

(52) U.S. Cl. CPC G05D 1/104; G08G 5/003; G08G 5/045

(57) ABSTRACT

System and method for controlling trajectory of an aircraft. The control system includes a position determination module to determine a safety position corresponding to a position in which a follower aircraft is not subject to effects of the right-hand and left-hand vortices generated by a leader aircraft while remaining in formation flight, a protection module to convey and to maintain the follower aircraft to/in the safety position when the follower aircraft comprises a wing tip located in a position that has a right-hand vortex signature that is less than or equal to a first predetermined signature or that has a left-hand vortex signature that is greater than or equal to the first predetermined signature or that has a right-hand vortex signature that is greater than or equal to a second predetermined signature or that has a left-hand vortex signature that is less than or equal to the second predetermined signature.

This application claims the benefit of and priority to French patent application number 18 52633 filed on Mar. 27, 2018, the entire disclosure of which is incorporated by reference herein.

### TECHNICAL FIELD

The disclosure herein relates to a method and a system for controlling the trajectory of an aircraft, called follower aircraft, likely to be subject to vortices generated by an aircraft, called leader aircraft, ahead of the follower aircraft, the leader and follower aircraft completing a formation flight.

### BACKGROUND

A formation flight comprises at least two aircraft, in particular transport airplanes, namely a leader aircraft and one or more follower aircraft. The follower aircraft fly by following the aircraft that they are directly following (namely the leader aircraft or another follower aircraft) in order to maintain a constant separation between them. In a particular application, in particular in cruising flight, the aircraft fly one behind the other at the same flight level, with the same heading and the same speed. Provision also can be made to apply speed control orders to the follower aircraft that are such that they allow the follower aircraft to have the same position, the same speed and the same acceleration that the leader aircraft had at given prior durations.

It is known that an aircraft in flight generates vortices in its wake (or wake turbulence). A vortex (or wake turbulence) is understood to be an aerodynamic turbulence (or eddy) that forms downstream of an aircraft.

An airplane in flight mainly generates two vortices in its wake, namely a right-hand vortex and a left-hand vortex respectively starting from each of the wings thereof due to the pressure difference between the pressure face and the suction face of the wing and the resulting downwards deflection of the airflow. These vortices are contra-rotating eddies and are characterized by a wind field that is generally ascending outside the eddies and is generally descending between the eddies.

From the wings, the vortices firstly tend to approach each other, then to maintain a fairly constant distance between each other, while losing altitude relative to the altitude at which they are generated.

Due to this configuration of the vortices, it is worthwhile for a follower aircraft following the leader aircraft generating the vortices to be able to benefit from the ascending winds, in order to reduce its fuel consumption and to thus take the follower aircraft to a suitable position.

However, the vortices can destabilize the flight of the follower aircraft locked on at least one of the vortices, which can impair the comfort of the aircraft passengers.

### SUMMARY

An aim of the disclosure herein is to overcome these disadvantages.

To this end, the disclosure herein relates to a method for controlling the trajectory of an aircraft, called follower aircraft, likely to be subject to a right-hand vortex generated on the right-hand side of an aircraft, called leader aircraft, or to a left-hand vortex generated on the left-hand side of the leader aircraft, the first and second vortices being generated by the leader aircraft ahead of the follower aircraft, the leader and follower aircraft completing a formation flight, the right-hand side and the left-hand side being defined looking in a direction of travel of the leader aircraft.

According to the disclosure herein, the control method comprises:
a position determination step, implemented by a position determination module, comprising determining, using a vortex transport model, a position, called safety position, corresponding to a position in which the follower aircraft is not subject to the effects of the left-hand or right-hand vortices generated by the leader aircraft while remaining in formation flight;
a first protection step, implemented by a first protection module, comprising conveying and maintaining the follower aircraft to/in the safety position when the follower aircraft comprises a wing tip located in a position:
   that has a right-hand vortex signature that is less than or equal to a first predetermined signature, the follower aircraft being maintained in a current position if the right-hand vortex signature is greater than the first predetermined signature; or
   that has a left-hand vortex signature that is greater than or equal to the first predetermined signature, the follower aircraft being maintained in the current position if the left-hand vortex signature is less than the first predetermined signature; or
   that has a right-hand vortex signature that is greater than or equal to a second predetermined signature, the follower aircraft being maintained in the current position if the right-hand vortex signature is less than the second predetermined signature; or
   that has a left-hand vortex signature that is less than or equal to the second predetermined signature, the follower aircraft being maintained in the current position if the left-hand vortex signature is greater than the second predetermined signature.

Thus, by virtue of the disclosure herein, the follower aircraft is protected against the vortex on which it is locked by monitoring the signature of the vortex. A possible change of sign of the signature indicating, for example, that the follower aircraft is beginning to be drawn in by the vortex causes the follower aircraft to move away to a safety position.

According to one feature, the first protection step comprises the following sub-steps:
a signature determination sub-step, implemented by a determination sub-module, comprising determining a right-hand vortex signature and a left-hand vortex signature;
a first control sub-step, implemented by a first control sub-module, comprising conveying and maintaining the follower aircraft to/in the safety position following a time delay, the time delay being triggered when one or other of the following events occurs:
   the follower aircraft located to the right of the right-hand vortex comprises a wing tip located in a position that has a right-hand vortex signature that is less than or equal to the first predetermined signature;
   the follower aircraft located to the left of the left-hand vortex comprises a wing tip located in a position that has a left-hand vortex signature that is greater than or equal to the first predetermined signature;
   the follower aircraft located to the right of the right-hand vortex comprises a wing tip located in a position that has a right-hand vortex signature that is greater than or equal to the second predetermined signature;
   the follower aircraft located to the left of the left-hand vortex comprises a wing tip located in a position that has a left-hand vortex signature that is less than or equal to the second predetermined signature;
a second control sub-step, implemented by a second control sub-module, comprising conveying and maintaining the follower aircraft to/in the current position when:
   the follower aircraft located to the right of the right-hand vortex comprises a wing tip located in a position that has a right-hand vortex signature that is greater than the first predetermined signature; or
   the follower aircraft located to the left of the left-hand vortex comprises a wing tip located in a position that has a left-hand vortex signature that is less than the first predetermined signature; or the follower aircraft located to the right of the right-hand vortex comprises a wing tip located in a position that has a right-hand vortex signature that is less than the second predetermined signature; or
   the follower aircraft located to the left of the left-hand vortex comprises a wing tip located in a position that has a left-hand vortex signature that is greater than the second predetermined signature.

Advantageously, the control method further comprises a second protection step, implemented by a second protection module, the leader aircraft flying at a first speed, the follower aircraft flying at a second speed, the second protection step comprising conveying and maintaining the follower aircraft to/in the safety position when the second speed and the first speed exhibit a difference that is greater than a deceleration criterion depending on the deceleration capability of the follower aircraft and on a desired distance margin in order for the follower aircraft to fly at the same speed as the leader aircraft, the follower aircraft being maintained in the current position if the difference between the second speed and the first speed is less than or equal to the deceleration criterion.

By virtue of this protection step, the follower aircraft is protected against any risks of colliding with the leader aircraft.

Furthermore, the deceleration criterion is expressed as follows: C=\sqrt{2γₘᵢₙ(ΔX₀−ΔX_{M})}, in which:
γₘᵢₙ represents the minimum deceleration capability of the follower aircraft;
ΔX₀ represents a distance between the leader aircraft and the follower aircraft when the follower aircraft flies at the second speed;
ΔX_{M} represents the desired distance margin in order for the follower aircraft to fly at the same speed as the leader aircraft.

Moreover, the control method further comprises a third protection step, implemented by a third protection module, comprising conveying and maintaining the follower aircraft to/in an auxiliary safety position when the leader aircraft performs an abnormal maneuver.

By virtue of this protection step, the follower aircraft is protected against the unexpected movements, such as an emergency descent, of the leader aircraft.

Furthermore, the third protection step comprises:
a vertical speed determination sub-step, implemented by a vertical speed determination sub-module, comprising determining the vertical speed of the leader aircraft;
a third control sub-step, implemented by a third control sub-module, comprising conveying and maintaining the follower aircraft to/in the auxiliary safety position when the vertical speed of the leader aircraft exhibits an absolute value that is greater than or equal to a predetermined vertical speed, the auxiliary safety position corresponding to the safety position determined in the position determination step.

Moreover, the third protection step further comprises:
a lateral attitude variation determination sub-step, implemented by a lateral attitude variation determination sub-module, comprising determining a lateral attitude variation of the leader aircraft;
a fourth control sub-step, implemented by a fourth control sub-module, comprising conveying and maintaining the follower aircraft to/in the auxiliary safety position when the lateral attitude variation of the leader aircraft exhibits an absolute value that is greater than or equal to a predetermined lateral attitude variation, the auxiliary safety position corresponding to the safety position determined in the position determination step decreased or increased by a predetermined height.

The disclosure herein also relates to a system for controlling the trajectory of an aircraft, called follower aircraft, likely to be subject to a right-hand vortex generated on the right-hand side of an aircraft, called leader aircraft, or to a left-hand vortex generated on the left-hand side of the leader aircraft, the first and second vortices being generated by the leader aircraft ahead of the follower aircraft, the leader and follower aircraft completing a formation flight, the right-hand side and the left-hand side being defined looking in a direction of travel of the leader aircraft.

According to the disclosure herein, the control system comprises:
a position determination module configured to determine, using a vortex transport model, a position, called safety position, corresponding to a position in which the follower aircraft is not subject to the effects of the left-hand or right-hand vortices generated by the leader aircraft while remaining in formation flight;
a first protection module configured to convey and to maintain the follower aircraft to/in the safety position when the follower aircraft comprises a wing tip located in a position:
   that has a right-hand vortex signature that is less than or equal to a first predetermined signature, the follower aircraft being maintained in the current position if the right-hand vortex signature is greater than the first predetermined signature; or
   that has a left-hand vortex signature that is greater than or equal to the first predetermined signature, the follower aircraft being maintained in the current position if the left-hand vortex signature is less than the first predetermined signature; or
   that has a right-hand vortex signature that is greater than or equal to a second predetermined signature, the follower aircraft being maintained in the current position if the right-hand vortex signature is less than the second predetermined signature; or
   that has a left-hand vortex signature that is less than or equal to the second predetermined signature, the follower aircraft being maintained in the current position if the left-hand vortex signature is greater than the second predetermined signature.

According to one feature, the first protection module comprises the following sub-modules:
a determination sub-module configured to determine a right-hand vortex signature and a left-hand vortex signature;
a first control sub-module configured to convey and to maintain the follower aircraft to/in the safety position following a time delay, the time delay being triggered when one or other of the following events occurs:
   the follower aircraft located to the right of the right-hand vortex comprises a wing tip located in a position that has a right-hand vortex signature that is less than or equal to the first predetermined signature;
   a the follower aircraft located to the left of the left-hand vortex comprises a wing tip located in a position that has a left-hand vortex signature that is greater than or equal to the first predetermined signature;
   the follower aircraft located to the right of the right-hand vortex comprises a wing tip located in a position that has a right-hand vortex signature that is greater than or equal to the second predetermined signature;
   a the follower aircraft located to the left of the left-hand vortex comprises a wing tip located in a position that has a left-hand vortex signature that is less than or equal to the second predetermined signature;
a second control sub-module configured to convey and to maintain the follower aircraft to/in the current position when:
   a the follower aircraft located to the right of the right-hand vortex comprises a wing tip located in a position that has a right-hand vortex signature that is greater than the first predetermined signature; or
   the follower aircraft located to the left of the left-hand vortex comprises a wing tip located in a position that has a left-hand vortex signature that is less than the first predetermined signature; or
   the follower aircraft located to the right of the right-hand vortex comprises a wing tip located in a position that has a right-hand vortex signature that is less than the second predetermined signature; or
   the follower aircraft located to the left of the left-hand vortex comprises a wing tip located in a position that has a left-hand vortex signature that is greater than the second predetermined signature.

Advantageously, the control system further comprises a second protection module, the leader aircraft flying at a first speed, the follower aircraft flying at a second speed, the second protection module being configured to convey and to maintain the follower aircraft to/in the safety position when the second speed and the first speed exhibit a difference that is greater than a deceleration criterion depending on the deceleration capability of the follower aircraft and on a desired distance margin in order for the follower aircraft to fly at the same speed as the leader aircraft, the follower aircraft being maintained in the current position if the difference between the second speed and the first speed is less than or equal to the deceleration criterion.

Moreover, the control system further comprises a third protection module configured to convey and to maintain the follower aircraft to/in an auxiliary safety position when the leader aircraft performs an abnormal maneuver.

According to one feature, the third protection module comprises:
a vertical speed determination sub-module configured to determine the vertical speed of the leader aircraft;
a third control sub-module configured to convey and to maintain the follower aircraft to/in the auxiliary safety position when the vertical speed of the leader aircraft exhibits an absolute value that is greater than or equal to a predetermined vertical speed, the auxiliary safety position corresponding to the safety position determined by the position determination module.

According to another feature, the third protection module further comprises:
a lateral attitude variation determination sub-module configured to determine a lateral attitude variation of the leader aircraft;
a fourth control sub-module configured to convey and to maintain the follower aircraft to/in the auxiliary safety position when the lateral attitude variation of the leader aircraft exhibits an absolute value that is greater than or equal to a predetermined lateral attitude variation, the auxiliary safety position corresponding to the safety position determined by the position determination module decreased or increased by a predetermined height.

The disclosure herein also relates to an aircraft, in particular a transport airplane, that comprises a system for controlling the trajectory of an aircraft as specified above.

### BRIEF DESCRIPTION OF THE DRAWINGS

The features and advantages of the disclosure herein will become more clearly apparent upon reading the description, which is provided with reference to the accompanying, example drawings, in which:

FIG. 1 schematically shows an embodiment of the control system;

FIG. 2 schematically shows an embodiment of the control method;

FIG. 3 is a schematic representation of a formation flight showing a leader aircraft generating vortices and two possible positions for a follower aircraft relative to these vortices;

FIG. 4 is a graph showing the signature values of a right-hand vortex generated by the right wing of a leader aircraft;

FIG. 5a shows a follower aircraft having a speed that is greater than a speed of a leader aircraft with which the follower aircraft flies in formation;

FIG. 5b shows a follower aircraft having a speed that is substantially equal to the speed of the leader aircraft with which the follower aircraft flies in formation at a desired distance margin;

FIG. 6 is a graph representing the deceleration criterion separating a region in which the follower aircraft can remain in its current position and a region in which the follower aircraft is conveyed to the safety position;

FIG. 7 is a schematic representation of a formation flight showing a leader aircraft performing a vertically abnormal maneuver and two possible positions for a follower aircraft; and

FIG. 8 is a schematic representation of a formation flight showing a leader aircraft performing a laterally abnormal maneuver and two possible positions for a follower aircraft.

### DETAILED DESCRIPTION

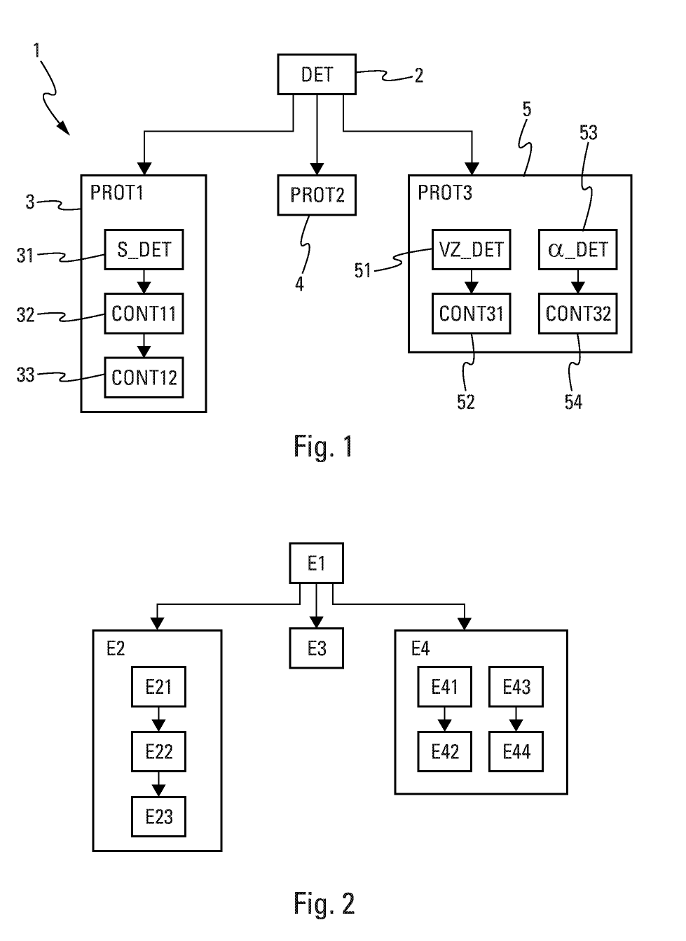

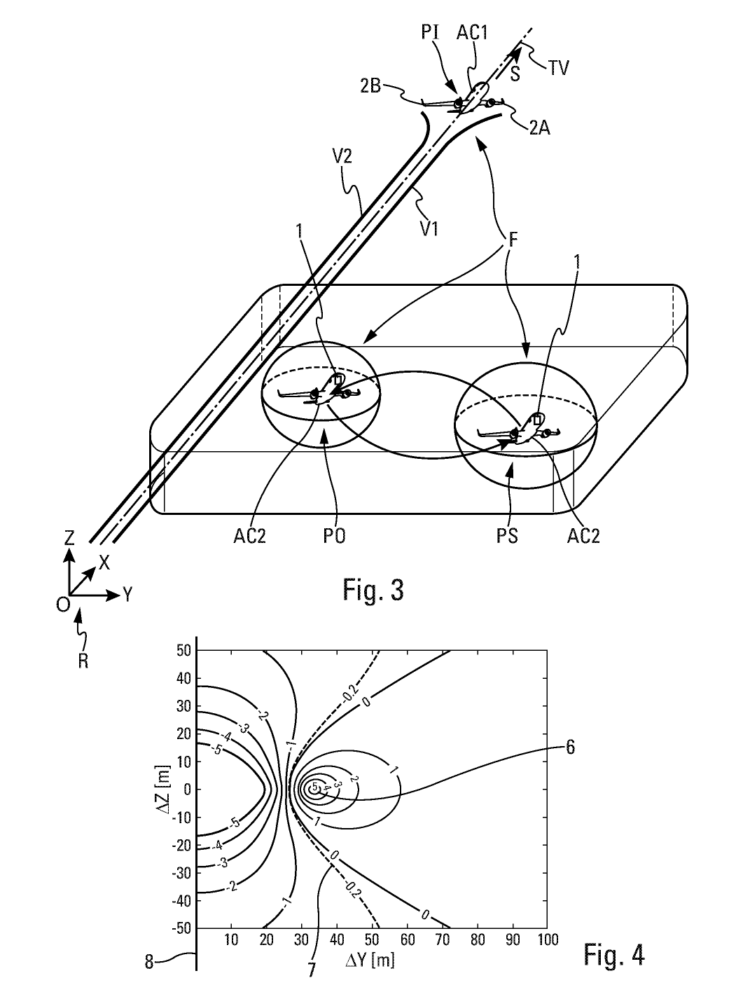

The control system 1 for illustrating the disclosure herein, and which is schematically shown in FIG. 1, is a system for controlling the trajectory of a follower aircraft AC2, relative to vortices V1 and V2 generated by a leader aircraft AC1 ahead of the follower aircraft, as shown in FIGS. 3, 7 and 8. The leader and follower aircraft AC1, AC2, for example two transport airplanes, complete a formation flight F. The control system 1 is mounted on board the follower aircraft AC2, as is highly schematically shown in FIG. 3.

The leader aircraft AC1 and the follower aircraft AC2 can correspond to a pair of aircraft, for which the leader aircraft AC1 is the leader aircraft AC1 of a whole formation F and the follower aircraft AC2 is the aircraft that follows directly behind the leader aircraft AC1. The leader aircraft AC1 and the follower aircraft AC2 can also correspond to a pair of aircraft, for which the leader aircraft AC1 is an aircraft that follows another aircraft and the follower aircraft AC2 is the aircraft that follows directly behind the leader aircraft AC1.

Conventionally, the formation F comprises the leader aircraft AC1 and one or more follower aircraft, namely a single follower aircraft AC2 in the example of FIG. 3, which follow the leader aircraft AC1 (located in a position PI) in order to maintain a constant separation between them. In a preferred application, in particular in cruising flight, the aircraft AC1 and AC2 fly one behind the other at the same flight level, with the same heading and the same speed.

In a preferred embodiment, the control system 1 forms part of a formation flight management unit (not specifically shown) that is on board the follower aircraft AC2. Such a unit is configured to manage the formation flight at least for the follower aircraft AC2.

The leader aircraft AC1 follows a flight trajectory TV and it mainly generates two vortices V1 and V2 in its wake, namely a vortex V1 and V2 each starting from the wings 2A and 2B thereof due to the pressure difference between the pressure face and the suction face of each wing and the resulting downwards deflection of the airflow. These vortices V1 and V2 are contra-rotating eddies and are characterized by a wind field that is generally ascending outside the eddies and is generally descending between the eddies. From the wings 2A and 2B, the vortices V1 and V2 firstly tend to approach each other, then to maintain a fairly constant distance between each other, whilst losing altitude relative to the altitude at which they are generated.

In order to facilitate the following description, an orthonormal coordinate system R is determined, which is shown in FIG. 3 and is formed by three axes (or directions) X, Y and Z orthogonal to each other and passing through a point O, which axes are such that:
X is the longitudinal axis of the fuselage of the leader aircraft AC1 positively oriented in the direction of travel S of the leader aircraft AC1;
Z is a vertical axis that forms a plane with the X axis corresponding to the vertical plane of symmetry of the leader aircraft AC1; and
Y is a transverse axis that is orthogonal to the X and Z axes.

Even though, for the sake of clarity, the point O is shown outside the leader aircraft AC1 in FIG. 3, it can correspond to the center of gravity of the leader aircraft AC1.

The control system 1 allows the trajectory to be controlled of a follower aircraft AC2 that is likely to be subject to a right-hand vortex V1 generated on the right-hand side of a leader aircraft AC1 or to a left-hand vortex V2 generated on the left-hand side of the leader aircraft AC1. The right-hand side and the left-hand side being defined looking in the direction of travel S of the leader aircraft AC1 in the direction of the X axis.

The control system 1 comprises, as shown in FIG. 1:
a position determination module DET 2 configured to determine, using a vortex transport model, a position PS, called safety position, corresponding to a position in which the follower aircraft AC2 is not subject to the effects of the left-hand or right-hand vortices V1, V2 generated by the leader aircraft AC1 while remaining in formation flight F;
a protection module PROT1 3 configured to convey and to maintain the follower aircraft AC2 to/in the safety position PS when the follower aircraft AC2 comprises a wing tip located in a position:
   that has a right-hand vortex V1 signature that is less than or equal to a first predetermined signature. The follower aircraft AC2 is maintained in the current position PO if the right-hand vortex V1 signature is greater than the first predetermined signature; or
   that has a left-hand vortex V2 signature that is greater than or equal to the first predetermined signature. The follower aircraft AC2 is maintained in the current position PO if the left-hand vortex V2 signature is less than the first predetermined signature; or
   that has a right-hand vortex V1 signature that is greater than or equal to a second predetermined signature, the follower aircraft AC2 being maintained in the current position PO if the right-hand vortex V1 signature is less than the second predetermined signature; or
   that has a left-hand vortex V2 signature that is less than or equal to the second predetermined signature, the follower aircraft AC2 being maintained in the current position PO if the left-hand vortex V2 signature is greater than the second predetermined signature.

The protection module 3 can comprise a determination sub-module S_DET 31 configured to determine a right-hand vortex V1 signature and a left-hand vortex V2 signature.

For example, the signature corresponds to a roll angle of the follower aircraft AC2 or to a roll command on board the follower aircraft AC2.

The signature of a vortex can be computed by subtracting between, on the one hand, an estimate of a response from the follower aircraft AC2 to the flight commands currently being applied, without influence from the vortex V1, V2 and, on the other hand, a value of a signal of the influence of the vortex V1, V2.

The protection module 3 also comprises a control sub-module CONT11 32 configured to convey and to maintain the follower aircraft AC2 to/in the safety position PS following a time delay, the time delay being triggered when one or other of the following events occurs:
the follower aircraft AC2 located to the right of the right-hand vortex V1 comprises a wing tip located in a position that has a right-hand vortex V1 signature that is less than or equal to the first predetermined signature;
the follower aircraft AC2 located to the left of the left-hand vortex V2 comprises a wing tip located in a position that has a left-hand vortex V2 signature that is greater than or equal to the first predetermined signature;
the follower aircraft AC2 located to the right of the right-hand vortex V1 comprises a wing tip located in a position that has a right-hand vortex V1 signature that is greater than or equal to the second predetermined signature;
the follower aircraft AC2 located to the left of the left-hand vortex V2 comprises a wing tip located in a position that has a left-hand vortex V2 signature that is less than or equal to the second predetermined signature.

In a non-limiting manner, the time delay can be between 1 ms and 10 ms.

The protection module 3 also comprises a control sub-module CONT12 33 configured to convey and to maintain the follower aircraft AC2 to/in the current position PO when:
the follower aircraft AC2 located to the right of the right-hand vortex V1 comprises a wing tip located in a position that has a right-hand vortex V1 signature that is greater than the first predetermined signature; or
the follower aircraft AC2 located to the left of the left-hand vortex V2 comprises a wing tip located in a position that has a left-hand vortex V2 signature that is less than the first predetermined signature; or
the follower aircraft AC2 located to the right of the right-hand vortex V1 comprises a wing tip located in a position that has a right-hand vortex V1 signature that is less than the second predetermined signature; or
the follower aircraft AC2 located to the left of the left-hand vortex V2 comprises a wing tip located in a position that has a left-hand vortex V2 signature that is greater than the second predetermined signature.

FIG. 4 corresponds to a graph showing the signature of the right-hand vortex V1, the center of which is coincident with the axis 8. Reference sign 6 shows the optimal position of the wing tip of a follower aircraft AC2 located to the right of the right-hand vortex V1. The line 7 represents the first predetermined signature. In the example of this figure, the first predetermined signature is set to −0.2. Thus, if the wing tip of the follower aircraft AC2 is located to the right of the line 7, the follower aircraft is not conveyed to the safety position PS. The follower aircraft AC2 is conveyed in order to move as close as possible to the optimal position. If the wing tip of the follower aircraft AC2 is located to the left of the line 7, the control sub-module 32 conveys and maintains the follower aircraft AC2 to/in the safety position PS after a time delay.

The second predetermined signature corresponds to a signature maximum. For example, in FIG. 4 the signature maximum is considered to correspond to the line corresponding to a signature set to 5. Thus, if the wing tip of the follower aircraft AC2 moves from right to left (for example, from a position in which the signature has a value of 1), the tip passes through a signature maximum (line corresponding to a signature set to 5), which corresponds to the second predetermined signature. Thus, if the wing tip of the follower aircraft AC2 is located to the right of the line for which the value is set to 5, the follower aircraft AC2 is not conveyed to the safety position PS. The follower aircraft AC2 is conveyed in order to move as close as possible to the optimal position. If the wing tip of the follower aircraft AC2 has passed the line for which the signature is set to 5 from right to left, the control sub-module 32 conveys and maintains the follower aircraft AC2 to/in the safety position PS after a time delay.

Advantageously, the control system 1 further comprises a protection module PROT2 4. The leader aircraft AC1 flies at a speed V_{L} and the follower aircraft AC2 flies at a speed V_{F}. The protection module 4 is configured to convey and to maintain the follower aircraft AC2 to/in the safety position PS when the speed V_{F} and the speed V_{L} exhibit a difference that is greater than a deceleration criterion C depending on the deceleration capability of the follower aircraft AC2 and on a desired distance margin ΔX_{M} in order for the follower aircraft AC2 to fly at the same speed as the leader aircraft AC1. The follower aircraft AC2 is maintained in the current position PO if the difference between the speed V_{F} and the speed V_{L} is less than or equal to the deceleration criterion C.

The protection module 4 can be configured to check whether the deceleration potential of the follower aircraft AC2 is sufficient in the event of excessive speed relative to the leader aircraft AC1, in order to stop the approach at a distance ΔX_{M} from the leader aircraft AC1.

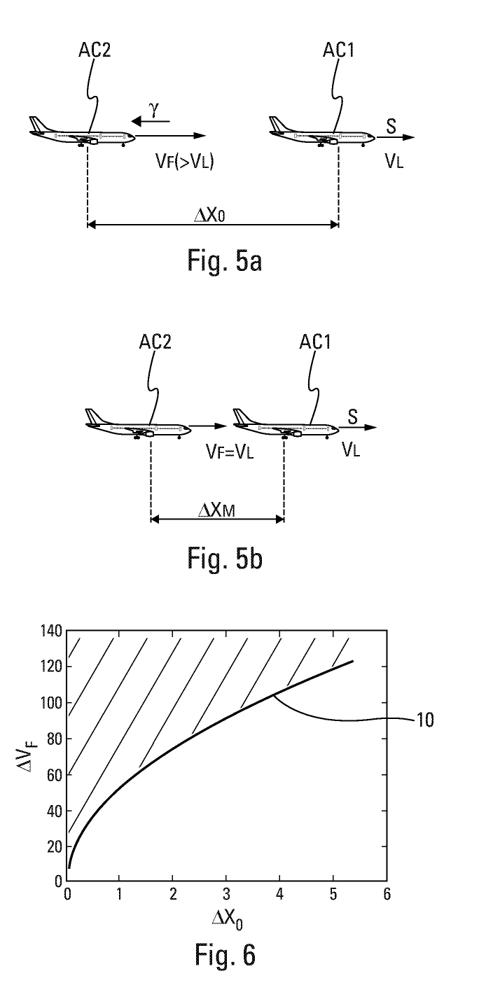

In a non-limiting manner, the deceleration criterion C is expressed as follows: C=\sqrt{2γₘᵢₙ(ΔX₀−ΔX_{M})}, in which (FIGS. 3a and 3b):
ΔV_{F} represents the difference between the speed V_{F} of the follower aircraft AC2 and the speed V_{L} of the leader aircraft AC2 (in m/s);
γₘᵢₙ represents the minimum deceleration capability of the follower aircraft AC2 (in m/s²);
ΔX₀ represents a distance between the leader aircraft AC1 and the follower aircraft AC2 when the follower aircraft AC2 flies at the speed V_{F} (in m) (FIG. 5a);
ΔX_{M} represents the desired distance margin in order for the follower aircraft AC2 to fly at the same speed as the leader aircraft AC1 (in m) (FIG. 5b).

In a non-limiting manner, the minimum deceleration capability of the follower aircraft AC2 is substantially equal to 0.2 m/s².

FIG. 6 shows ΔV_{F} on the basis of ΔX₀. The shaded area above the line 10 represents the deceleration criterion separating a region in which the protection module 4 conveys and maintains the follower aircraft AC2 to/in the safety position PS of a region in which the follower aircraft AC2 can remain in its current position PS.

More advantageously, the control system 1 comprises a protection module PROT3 5 configured to convey and to maintain the follower aircraft AC2 to/in an auxiliary safety position PS, PSA when the leader aircraft AC1 performs an abnormal maneuver.

An abnormal maneuver corresponds, for example, to an increase in vertical speed resulting in a vertical speed V_{Z} that is greater than a predetermined vertical speed. An abnormal maneuver can also correspond to an increase in the variation of the lateral attitude resulting in a lateral attitude variation that is greater than a predetermined lateral attitude variation.

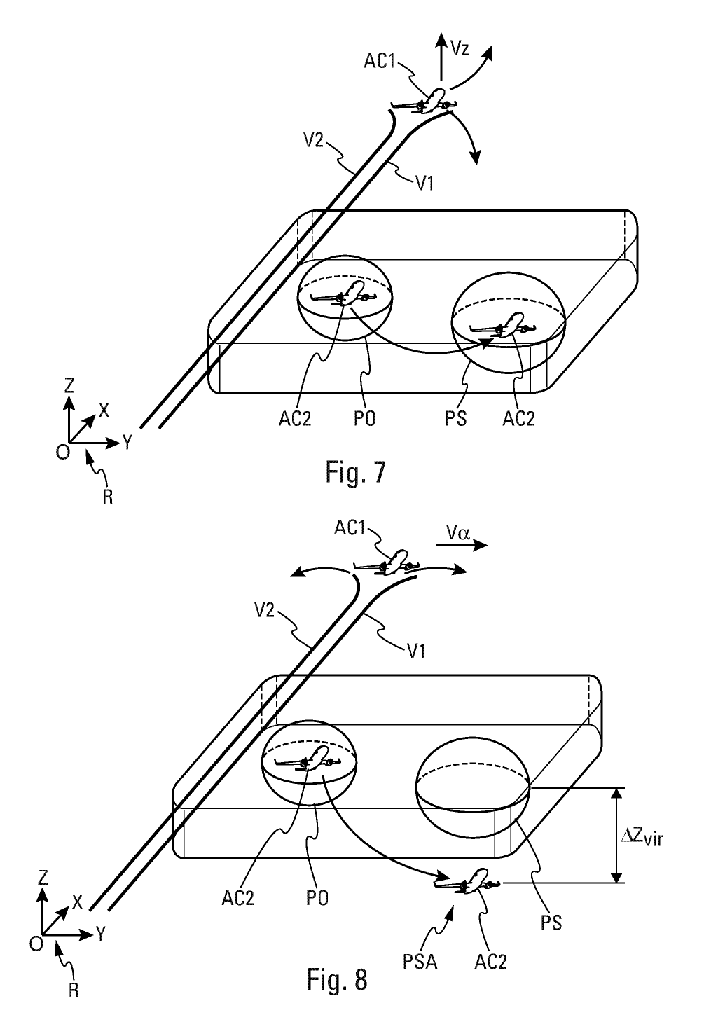

According to one feature, the protection module 5 comprises:
a vertical speed determination sub-module VZ_DET 51 configured to determine the vertical speed V_{Z} of the leader aircraft AC1;
a control sub-module CONT31 52 configured to convey and to maintain the follower aircraft AC2 to/in the auxiliary safety position PS when the vertical speed V_{Z} of the leader aircraft AC1 exhibits an absolute value that is greater than or equal to a predetermined vertical speed, the auxiliary safety position PS corresponding to the safety position PS determined by the position determination module 2 (FIG. 7).

According to another feature, the protection module 5 further comprises:
a lateral attitude variation determination sub-module α_DET 53 configured to determine the lateral attitude variation V_{α} of the leader aircraft AC1;
a fourth control sub-module configured to convey and to maintain the follower aircraft AC2 to/in the auxiliary safety position when the lateral attitude variation of the leader aircraft AC1 exhibits an absolute value that is greater than or equal to a predetermined lateral attitude variation, the auxiliary safety position corresponding to the safety position determined by the position determination module 2 reduced or increased by a predetermined height ΔZᵥᵢᵣ (FIG. 8).

The predetermined height ΔZᵥᵢᵣ allows the follower aircraft AC2 to be safeguarded against a vortex crossover in the event that the leader aircraft AC1 turns towards the follower aircraft AC2.

In a non-limiting manner, the predetermined height ΔZᵥᵢᵣ is within a range ranging from 30 m to 300 m.

The disclosure herein also relates to a control method (FIG. 2) comprising:
a position determination step E1, implemented by the position determination module 2, comprising determining, using a vortex transport model, the safety position PS;
a protection step E2, implemented by the protection module 3; comprising conveying and maintaining the follower aircraft AC2 to/in the safety position PS when the follower aircraft AC2 comprises a wing tip located in a position:
   that has a right-hand vortex V1 signature that is less than or equal to the first predetermined signature, the follower aircraft AC2 being maintained in the current position PO if the right-hand vortex V1 signature is greater than the first predetermined signature; or
   that has a left-hand vortex V2 signature that is greater than or equal to the first predetermined signature, the follower aircraft AC2 being maintained in the current position PO if the left-hand vortex V2 signature is less than the first predetermined signature; or
   that has a right-hand vortex V1 signature that is greater than or equal to a second predetermined signature, the follower aircraft AC2 being maintained in the current position PO if the right-hand vortex V1 signature is less than the second predetermined signature; or
   a that has a left-hand vortex V2 signature that is less than or equal to the second predetermined signature, the follower aircraft AC2 being maintained in the current position PO if the left-hand vortex V2 signature is greater than the second predetermined signature.

The first protection step E2 can comprise the following sub-steps:
a signature determination sub-step E21, implemented by the determination sub-module 31, comprising determining the right-hand vortex V1 signature and the left-hand vortex V2 signature;
a control sub-step E22, implemented by the control sub-module 32, comprising conveying and maintaining the follower aircraft AC2 to/in the safety position PS following a time delay, the time delay being triggered when one or other of the following events occurs:
   the follower aircraft AC2 located to the right of the right-hand vortex V1 comprises a wing tip located in a position that has a right-hand vortex V1 signature that is less than or equal to the first predetermined signature;
   the follower aircraft AC2 located to the left of the left-hand vortex V2 comprises a wing tip located in a position that has a left-hand vortex V2 signature that is greater than or equal to the first predetermined signature;
   the follower aircraft AC2 located to the right of the right-hand vortex V1 comprises a wing tip located in a position that has a right-hand vortex V1 signature that is greater than or equal to the second predetermined signature;
   the follower aircraft AC2 located to the left of the left-hand vortex V2 comprises a wing tip located in a position that has a left-hand vortex V2 signature that is less than or equal to the second predetermined signature;
a control sub-step E23, implemented by the control sub-module 33, comprising conveying and maintaining the follower aircraft AC2 to/in the current position PO when:
   the follower aircraft AC2 located to the right of the right-hand vortex V1 comprises a wing tip located in a position that has a right-hand vortex V1 signature that is greater than the first predetermined signature; or
   the follower aircraft AC2 located to the left of the left-hand vortex V2 comprises a wing tip located in a position that has a left-hand vortex V2 signature that is less than the first predetermined signature; or
   the follower aircraft AC2 located to the right of the right-hand vortex V1 comprises a wing tip located in a position that has a right-hand vortex V1 signature that is less than the second predetermined signature; or
   the follower aircraft AC2 located to the left of the left-hand vortex V2 comprises a wing tip located in a position that has a left-hand vortex V2 signature that is greater than the second predetermined signature.

The control method can further comprise a protection step E3 implemented by the protection module 4. The protection step E3 involves conveying and maintaining the follower aircraft AC2 to/in the safety position PS when the second speed V_{F} and the first speed V_{L} exhibit a difference that is greater than the deceleration criterion C depending on the deceleration capability of the follower aircraft AC2 and on the desired distance margin ΔX_{M} in order for the follower aircraft AC2 to fly at the same speed as the leader aircraft AC1. The follower aircraft AC2 is maintained in the current position PO if the difference between the second speed V_{F} and the first speed V_{L} is less than or equal to the deceleration criterion C.

The control method can further comprise a protection step E4, implemented by the protection module 5, comprising conveying and maintaining the follower aircraft AC2 to/in the auxiliary safety position PS, PSA when the leader aircraft AC1 performs an abnormal maneuver.

Thus, the protection step E4 can comprise:
a vertical speed determination sub-step E41, implemented by the vertical speed determination sub-module 51, comprising determining the vertical speed of the leader aircraft AC1;
a control sub-step E42, implemented by the control sub-module 52, comprising conveying and maintaining the follower aircraft AC2 to/in the auxiliary safety position PS when the vertical speed V_{Z} of the leader aircraft AC1 exhibits an absolute value that is greater than or equal to the predetermined vertical speed, the auxiliary safety position PS corresponding to the safety position PS determined in the position determination step E1.

Furthermore, the protection step E4 can comprise:
a lateral attitude determination sub-step E43, implemented by the lateral attitude variation determination sub-module 53, comprising determining the lateral attitude variation of the leader aircraft AC1;
a control sub-step E44, implemented by the control sub-module 54, comprising conveying and maintaining the follower aircraft AC2 to/in the auxiliary safety position PSA when the lateral attitude variation V_{α} of the leader aircraft AC1 exhibits an absolute value that is greater than or equal to a predetermined lateral attitude variation, the auxiliary safety position PSA corresponding to the safety position PS determined in the position determination step E1 decreased or increased by a predetermined height ΔZᵥᵢᵣ.

This control method can be extended, through sufficient knowledge of the environment of the aircraft AC, to configurations other than formation flight for protection against vortices. For example, it can be extended to configurations for protection against vortices encountered in airports during landing phases.

The subject matter disclosed herein can be implemented in or with software in combination with hardware and/or firmware. For example, the subject matter described herein can be implemented in software executed by a processor or processing unit. In one exemplary implementation, the subject matter described herein can be implemented using a computer readable medium having stored thereon computer executable instructions that when executed by a processor of a computer control the computer to perform steps. Exemplary computer readable mediums suitable for implementing the subject matter described herein include non-transitory devices, such as disk memory devices, chip memory devices, programmable logic devices, and application specific integrated circuits. In addition, a computer readable medium that implements the subject matter described herein can be located on a single device or computing platform or can be distributed across multiple devices or computing platforms.

While at least one exemplary embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the term “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for controlling trajectory of a follower aircraft likely to be subject to a right-hand vortex generated on a right-hand side of a leader aircraft, or to a left-hand vortex generated on a left-hand side of the leader aircraft, the first and second vortices being generated by the leader aircraft ahead of the follower aircraft, the leader and follower aircraft completing a formation flight, the right-hand side and the left-hand side being defined looking in a direction of travel of the leader aircraft,
the method comprising:
a position determination step, implemented by a position determination module, comprising determining, using a vortex transport model, a safety position corresponding to a position in which the follower aircraft is not subject to effects of the left-hand or right-hand vortices generated by the leader aircraft while remaining in formation flight;
a first protection step, implemented by a first protection module, comprising conveying and maintaining the follower aircraft to or in the safety position when the follower aircraft comprises a wing tip located in a position:
that has a right-hand vortex signature that is less than or equal to a first predetermined signature, the follower aircraft being maintained in a current position if the right-hand vortex signature is greater than the first predetermined signature; or
that has a left-hand vortex signature that is greater than or equal to the first predetermined signature, the follower aircraft being maintained in a current position if the left-hand vortex signature is less than the first predetermined signature; or
that has a right-hand vortex signature that is greater than or equal to a second predetermined signature, the follower aircraft being maintained in a current position if the right-hand vortex signature is less than the second predetermined signature; or
that has a left-hand vortex signature that is less than or equal to the second predetermined signature, the follower aircraft being maintained in a current position if the left-hand vortex signature is greater than the second predetermined signature.

2. The method according to claim 1, wherein the first protection step comprises:
a signature determination sub-step, implemented by a determination sub-module, comprising determining a right-hand vortex signature and a left-hand vortex signature;
a first control sub-step, implemented by a first control sub-module, comprising conveying and maintaining the follower aircraft to or in the safety position following a time delay, the time delay being triggered when one or other of the following events occurs:
the follower aircraft located to a right of the right-hand vortex comprises a wing tip located in a position that has a right-hand vortex signature that is less than or equal to the first predetermined signature;
the follower aircraft located to a left of the left-hand vortex comprises a wing tip located in a position that has a left-hand vortex signature that is greater than or equal to the first predetermined signature;
the follower aircraft located to the right of the right-hand vortex comprises a wing tip located in a position that has a right-hand vortex signature that is greater than or equal to the second predetermined signature;
the follower aircraft located to the left of the left-hand vortex comprises a wing tip located in a position that has a left-hand vortex signature that is less than or equal to the second predetermined signature;
a second control sub-step, implemented by a second control sub-module, comprising conveying and maintaining the follower aircraft to or in a current position when:
the follower aircraft located to the right of the right-hand vortex comprises a wing tip located in a position that has a right-hand vortex signature that is greater than the first predetermined signature; or
the follower aircraft located to the left of the left-hand vortex comprises a wing tip located in a position that has a left-hand vortex signature that is less than the first predetermined signature; or
the follower aircraft located to the right of the right-hand vortex comprises a wing tip located in a position that has a right-hand vortex signature that is less than the second predetermined signature; or
the follower aircraft located to the left of the left-hand vortex comprises a wing tip located in a position that has a left-hand vortex signature that is greater than the second predetermined signature.

3. The method according to claim 1, further comprising a second protection step, implemented by a second protection module, the leader aircraft flying at a first speed (V_{L}), the follower aircraft flying at a second speed (V_{F}), the second protection step comprising conveying and maintaining the follower aircraft to or in the safety position when the second speed (V_{F}) and the first speed (V_{L}) exhibit a difference that is greater than a deceleration criterion (C) depending on the deceleration capability of the follower aircraft and on a desired distance margin (ΔX_{M}) in order for the follower aircraft to fly at a same speed as the leader aircraft, the follower aircraft being maintained in a current position if a difference between the second speed (V_{F}) and the first speed (V_{L}) is less than or equal to the deceleration criterion (C).

4. The method according to claim 3,
wherein the deceleration criterion (C) is expressed as follows: C=\sqrt{2γₘᵢₙ(ΔX₀−ΔX_{M})}, in which:
γₘᵢₙ represents a minimum deceleration capability of the follower aircraft (AC2);
ΔX₀ represents a distance between the leader aircraft and the follower aircraft when the follower aircraft flies at the second speed (V_{F});
ΔX_{M} represents a desired distance margin in order for the follower aircraft (AC2) to fly at a same speed as the leader aircraft.

5. The method according to claim 1, further comprising a third protection step, implemented by a third protection module, comprising conveying and maintaining the follower aircraft to or in an auxiliary safety position when the leader aircraft performs an abnormal maneuver.

6. The method according to claim 5, wherein the third protection step comprises:
a vertical speed determination sub-step, implemented by a vertical speed determination sub-module, comprising determining the vertical speed (V_{Z}) of the leader aircraft; and
a third control sub-step, implemented by a third control sub-module, comprising conveying and maintaining the follower aircraft to or in the auxiliary safety position when the vertical speed (V_{Z}) of the leader aircraft exhibits an absolute value that is greater than or equal to a predetermined vertical speed, the auxiliary safety position corresponding to the safety position determined in the position determination step.

7. The method according to claim 5, wherein the third protection step further comprises:
a lateral attitude variation determination sub-step, implemented by a lateral attitude variation determination sub-module, comprising determining a lateral attitude variation (V_{α}) of the leader aircraft; and
a fourth control sub-step, implemented by a fourth control sub-module, comprising conveying and maintaining the follower aircraft to or in the auxiliary safety position when the lateral attitude variation (V_{α}) of the leader aircraft exhibits an absolute value that is greater than or equal to a predetermined lateral attitude variation, the auxiliary safety position corresponding to the safety position determined in the position determination step decreased or increased by a predetermined height (ΔZᵥᵢᵣ).

8. A system for controlling trajectory of a follower aircraft likely to be subject to a right-hand vortex generated on a right-hand side of a leader aircraft, or to a left-hand vortex generated on a left-hand side of the leader aircraft, the first and second vortices being generated by the leader aircraft ahead of the follower aircraft, the leader and follower aircraft completing a formation flight, the right-hand side and the left-hand side being defined looking in a direction of travel of the leader aircraft,
the system comprising:
a position determination module configured to determine, using a vortex transport model, a safety position corresponding to a position in which the follower aircraft is not subject to effects of the left-hand or right-hand vortices generated by the leader aircraft while remaining in formation flight;
a first protection module configured to convey and to maintain the follower aircraft to or in the safety position when the follower aircraft comprises a wing tip located in a position:
that has a right-hand vortex signature that is less than or equal to a first predetermined signature, the follower aircraft being maintained in a current position if the right-hand vortex signature is greater than the first predetermined signature; or
that has a left-hand vortex signature that is greater than or equal to the first predetermined signature, the follower aircraft being maintained in a current position if the left-hand vortex signature is less than the first predetermined signature; or
that has a right-hand vortex signature that is greater than or equal to a second predetermined signature, the follower aircraft being maintained in a current position if the right-hand vortex signature is less than the second predetermined signature; or
that has a left-hand vortex signature that is less than or equal to the second predetermined signature, the follower aircraft being maintained in a current position if the left-hand vortex signature is greater than the second predetermined signature.

9. The system according to claim 8, wherein the first protection module comprises:
a determination sub-module configured to determine a right-hand vortex signature and a left-hand vortex signature;
a first control sub-module configured to convey and to maintain the follower aircraft to or in the safety position following a time delay, the time delay being triggered when one of the following events occurs:
the follower aircraft located to a right of the right-hand vortex comprises a wing tip located in a position that has a right-hand vortex signature that is less than or equal to the first predetermined signature;
the follower aircraft located to a left of the left-hand vortex comprises a wing tip located in a position that has a left-hand vortex signature that is greater than or equal to the first predetermined signature;
the follower aircraft located to the right of the right-hand vortex comprises a wing tip located in a position that has a right-hand vortex signature that is greater than or equal to the second predetermined signature;
the follower aircraft located to the left of the left-hand vortex comprises a wing tip located in a position that has a left-hand vortex signature that is less than or equal to the second predetermined signature;
a second control sub-module configured to convey and to maintain the follower aircraft to or in a current position when:
the follower aircraft located to the right of the right-hand vortex comprises a wing tip located in a position that has a right-hand vortex signature that is greater than the first predetermined signature; or
the follower aircraft located to the left of the left-hand vortex comprises a wing tip located in a position that has a left-hand vortex signature that is less than the first predetermined signature; or
the follower aircraft located to the right of the right-hand vortex comprises a wing tip located in a position that has a right-hand vortex signature that is less than the second predetermined signature; or
the follower aircraft located to the left of the left-hand vortex comprises a wing tip located in a position that has a left-hand vortex signature that is greater than the second predetermined signature.

10. The system according to claim 8, further comprising a second protection module, the leader aircraft flying at a first speed (V_{L}), the follower aircraft flying at a second speed (V_{F}), the second protection module being configured to convey and to maintain the follower aircraft to or in the safety position when the second speed (V_{F}) and the first speed (V_{L}) exhibit a difference that is greater than a deceleration criterion (C) depending on the deceleration capability of the follower aircraft and on a desired distance margin (ΔX_{M}) in order for the follower aircraft to fly at the same speed as the leader aircraft, the follower aircraft being maintained in a current position if a difference between the second speed (V_{F}) and the first speed (V_{L}) is less than or equal to the deceleration criterion (C).

11. The system according to claim 8, further comprising a third protection module configured to convey and to maintain the follower aircraft to or in an auxiliary safety position when the leader aircraft performs an abnormal maneuver.

12. The system according to claim 11, wherein the third protection module comprises:
a vertical speed determination sub-module configured to determine the vertical speed (V_{Z}) of the leader craft; and
a third control sub-module configured to convey and to maintain the follower aircraft to or in the auxiliary safety position when the vertical speed (V_{Z}) of the leader aircraft exhibits an absolute value that is greater than or equal to a predetermined vertical speed, the auxiliary safety position corresponding to the safety position determined by the position determination module.

13. The system according to claim 11, wherein the third protection module further comprises:
a lateral attitude variation determination sub-module configured to determine a lateral attitude variation (V_{α}) of the leader aircraft; and
a fourth control sub-module configured to convey and to maintain the follower aircraft to or in the auxiliary safety position when the lateral attitude variation (V_{α}) of the leader aircraft exhibits an absolute value that is greater than or equal to a predetermined lateral attitude variation, the auxiliary safety position corresponding to the safety position determined by the position determination module decreased or increased by a predetermined height (ΔZᵥᵢᵣ).

14. An aircraft comprising a system for controlling a trajectory of an aircraft according to claim 8.
